(19) United States
(12) Patent Application Publication
(10) Pub. No.: US 2014/0315513 A1
(43) Pub. Date: Oct. 23, 2014

(54) METHOD FOR MAKING EMERGENCY CALL, MOBILE ELECTRONIC DEVICE AND COMPUTER READABLE STORAGE MEDIUM

(71) Applicant: TENCENT TECHNOLOGY (SHENZHEN) COMPANY LIMITED, Shenzhen City (CN)

(72) Inventor: Jiejun LONG, Shenzhen City (CN)

(21) Appl. No.: 14/314,368

(22) Filed: Jun. 25, 2014

Related U.S. Application Data
(63) Continuation of application No. PCT/CN2014/074714, filed on Apr. 3, 2014.

(30) Foreign Application Priority Data
Apr. 19, 2013 (CN) 201310137159.3

(51) Int. Cl. H04W 4/22; H04W 64/00

(52) U.S. Cl. CPC H04W 4/22; H04W 64/00
USPC 455/404.2

(57) ABSTRACT

The present document discloses a method of making an emergency call in a mobile electronic device. In one embodiment, the method includes: detecting whether a user interaction with the mobile electronic device triggers an emergency calling mode; positioning a current location of the mobile electronic device using an embedded positioning service; and sending an emergency message, from the mobile electronic device, to a server, the emergency message at least comprising the current location. The present document also discloses a mobile electronic device and a computer readable storage medium.

### CROSS REFERENCE

The application is a U.S. continuation application under 35 U.S.C. §111(a) claiming priority under 35 U.S.C. §§120 and 365(c) to International Application No. PCT/CN2014/074714 filed Apr. 3, 2014, which claims the priority benefit of CN patent application serial No. 201310137159.3, titled “method and apparatus for making an emergency call in a mobile electronic device” and filed on Apr. 19, 2013, the contents of which are incorporated by reference herein in their entirety for all intended purposes.

### TECHNICAL FIELD

The present invention relates to network communication fields, and more particularly to a method for making an emergency call, a mobile electronic device and a computer readable storage medium.

### BACKGROUND

When people are in danger, the most direct ways to deal with the situations includes: crying out for help to the surrounding, calling the police or seek professional assistance agencies, or publishing information on social media for help. However, the calling for help is only sent to a limited scope and there may not be adequate people having the ability to rescue the caller. Under some situations, public assistance agencies, such as police states or hospitals, are too far from the caller, and thus those persons in danger can't quickly get effective help.

### SUMMARY

In view of above problem, there is a desire to provide a method capable of solving the problem.

A method of making an emergency call in a mobile electronic device includes: detecting whether a user interaction with the mobile electronic device triggers an emergency calling mode; positioning a current location of the mobile electronic device using an embedded positioning service; and sending an emergency message, from the mobile electronic device, to a server, the emergency message at least comprising the current location.

A mobile electronic device includes memory, one or more processors; and one or more modules stored in the memory and configured for execution by the one or more processors. The one or more modules comprising instructions: to detect whether a user interaction with the mobile electronic device triggers an emergency calling mode; to position a current location of the mobile electronic device using an embedded positioning service; and to send an emergency message, from the mobile electronic device, to a server, the emergency message at least comprising the current location.

A computer readable storage medium, storing one or more modules, which when executed by a mobile electronic device, causes the mobile electronic device to perform a method including: detecting whether a user interaction with the mobile electronic device triggers an emergency calling mode; positioning a current location of the mobile electronic device using an embedded positioning service; and sending an emergency message, from the mobile electronic device, to a server, the emergency message at least comprising the current location.

According to above method, the emergency calling mode is triggered by user interaction. Then, the current location of the mobile electronic device is obtained automatically. The emergency message sent to the serve includes the current location. Therefore, the server is capable of finding out terminals around the current location, and the efficiency of providing emergency aid is improved.

The above description is only an overview of the technical solutions of the present invention. In order to understand the technical solutions of the present invention more clearly, implement the technical solutions of the present invention according to the following specification, and make the purpose, the characteristics, and the advantages of the present invention more easily to understand, hereinafter, combined with accompanying drawings, embodiments of the present invention are described as follows.

### BRIEF DESCRIPTION OF THE DRAWINGS

FIG. 1 is a schematic view of a mobile electronic device.

FIG. 2 is a schematic view of an emergency calling system in accordance with a first embodiment.

FIG. 3 is a sequence diagram of the emergency calling system.

FIG. 4 is a flow chart of a method of making an emergency call in a mobile electronic device in accordance with a second embodiment.

FIG. 5 is a schematic view of the mobile electronic device shown in FIG. 1.

FIG. 6 is another schematic view of the mobile electronic device shown in FIG. 1.

FIG. 7 is yet another schematic view of the mobile electronic device shown in FIG. 1.

FIG. 8 is a flow chart of a method of making an emergency call in a mobile electronic device in accordance with a third embodiment.

FIG. 9 is a schematic view of the mobile electronic device shown in FIG. 1.

FIG. 10 is a flow chart of a method of making an emergency call in a mobile electronic device in accordance with a fourth embodiment.

FIG. 11 is a flow chart of a method of making an emergency call in a mobile electronic device in accordance with a fifth embodiment.

FIGS. 12 and 13 are block diagrams of a mobile electronic device in accordance with a sixth embodiment.

FIG. 14 is a block diagram of a mobile electronic device in accordance with a seventh embodiment.

FIG. 15 is a block diagram of a mobile electronic device in accordance with an eighth embodiment.

FIG. 16 is a block diagram of a mobile electronic device in accordance with a ninth embodiment.

### DETAILED DESCRIPTION OF PREFERRED EMBODIMENTS

The present invention will now be described more specifically with reference to the following embodiments. Hereinafter, combined with the accompanying drawings of the embodiments of the present invention, the purpose, technical solutions and advantages of the embodiments of the present invention are clearly and fully described as follows.

The document discloses a method of making an emergency call in a mobile electronic device, a mobile electronic device and a computer readable storage medium. Examples of the mobile electronic device includes, but not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), an on-vehicle device running any of the above-mentioned operating systems or any other operating systems, or a wearable electronic device (including, but not limited to, a helm, a watch, or a wristlet), all of which are well known to those skilled in the art. The emergency call means the user sends an emergency message for calling help under state of emergency using the mobile electronic device. The emergency situations includes, but not limited to, sudden illness, accidents, natural disasters, terrorist attacks, and other distress situations.

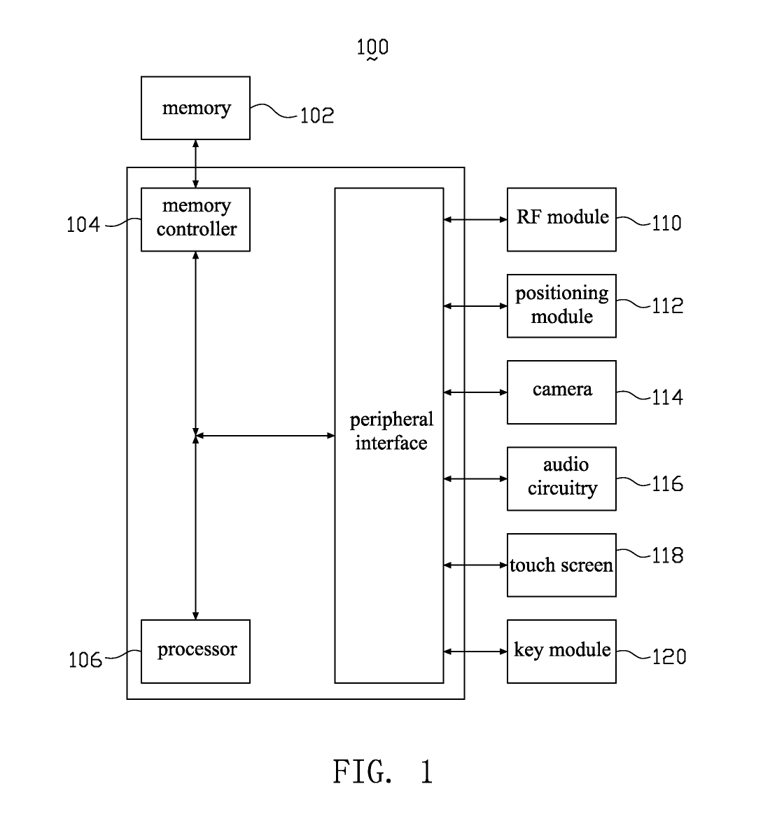

FIG. 1 is a schematic view of a mobile electronic device. As shown in FIG. 1, a mobile electronic device 100 includes a memory 102, a memory controller 104, one or more (only one is shown in FIG. 1) processors 106, a peripherals interface 108, a RF circuitry 110, a positioning module 112, a camera 114, an audio circuitry 116, a touch screen 118, and a key module 120. These components communicate over the one or more communication buses or signal lines 122.

It should be appreciated that the mobile electronic device 100 is only one example of a portable electronic device 100, and that the mobile electronic device 100 may have more or fewer components that shown, or a different configuration of components. The various components shown in FIG. 1 may be implemented in hardware, software or a combination of both hardware and software, including one or more signal processing and/or application specific integrated circuits.

The memory 102 stores software programs or modules, such as programs or instructions for performing the method of making an emergency call in the mobile electronic device 100. The one or more processors 106 execute the software programs or modules stored in the memory 102. As a result, the mobile electronic device 100 performs the method of making an emergency call.

The memory 102 may include high speed random access memory and may also include non-volatile memory, such as one or more magnetic disk storage devices, flash memory devices, or other non-volatile solid state memory devices. In some embodiments, the memory 102 may further include storage remotely located from the one or more processors 106, for instance network attached storage accessed via the RF circuitry 110 or external port (not shown) and a communications network (not shown) such as the Internet, intranet(s), Local Area Networks (LANs), Wireless Local Area Networks (WLANs), Storage Area Networks (SANs) and the like, or any suitable combination thereof. Access to the memory 102 by other components of the mobile electronic device 100, such as the processors 106 and the peripherals interface 108 may be controlled by the memory controller 104.

The peripherals interface 108 couples the input and output peripherals of the device to the one or more processors 106 and the memory 102. The one or more processors 106 run various software programs and/or sets of instructions stored in the memory 102 to perform various functions for the mobile electronic device 100 and to process data.

In some embodiments, the peripherals interface 108, the one or more processors 106, and the memory controller 104 may be implemented on a single chip, such as a chip 111. In some other embodiments, they may be implemented on separate chips.

The RF (radio frequency) circuitry 110 receives and sends electromagnetic waves. The RF circuitry 110 converts electrical signals to/from electromagnetic waves and communicates with communications networks and other communications devices via the electromagnetic waves. The RF circuitry 110 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 110 may communicate with the networks, such as the internet, also referred to as the World Wide Web (WWW), and Intranet and/or a wireless network, such as a cellular telephone network, a wireless local area network (WLAN) and/or a metropolitan area network (MAN), and other devices by wireless communication. The wireless communication may use any of a plurality of communications standards, protocols and technologies, including but not limited to Global System for Mobile communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 80.11n), voice over Internet Protocol (VoIP), Wi-MAX, a protocol for email, instant messaging, and/or Short Message Services (SMS)), or any other suitable communication protocol, including communication protocols not yet developed as of the filling date of this document.

The positioning module 112 positions the current location of the mobile electronic device 100. The positioning module 112 may be based on a global positioning system (GPS), BeiDou Navigation Satellite System (BDS), Global Navigation Satellite System (GLONASS), or wireless positioning system.

The camera 114 can be used to take photos or videos. The photos and videos can be stored in the memory 102, and can be sent using the RF module 110. Usually, the cameral 114 includes a lens module and an image sensor. The image sensor, for example, can be a charge-coupled device (CCD) image sensor, or a complementary metal oxide semiconductor (CMOS) image sensor.

The audio circuitry 116 provides an audio interface between a user and the mobile electronic device 100. The audio circuitry 118 receives audio data from the peripherals interface 108, converts the audio data to an electrical signal, and transmits the electrical signal to the speaker 116. The speaker converts the electrical signal to human-audible sound waves. The audio circuitry 116 also receives electrical signals converted by the microphone 121 from sound waves. The audio circuitry 116 converts the electrical signal to audio data and transmits the audio data to the peripherals interface 108 for processing. Audio data may be may be retrieved from and/or transmitted to the memory 102 and/or the RF circuitry 110 by the peripherals interface 108. In some embodiments, the audio circuitry 116 also includes a headset jack (not shown). The headset jack provides an inter-face between the audio circuitry 116 and removable audio input/output peripherals, such as output-only headphones or a headset with both output (headphone for one or both ears) and input (microphone).

The touch screen 118 provides both an output interface and an input interface between the device and a user. The touch screen 118 displays visual output to the user. The visual output may include text, graphics, video, and any combination thereof. Some or all of the visual output may correspond to user-interface objects, further details of which are described below.

The touch screen 118 also accepts input from the user based on haptic and/or tactile contact. The touch screen 118 forms a touch-sensitive surface that accepts user input. The touch screen 118 detects contact (and any movement or break of the contact) on the touch screen 118 and converts the detected contact into interaction with user-interface objects, such as one or more soft keys, that displayed on the touch screen. In an exemplary embodiment, a point of contact between the touch screen 118 and the user corresponds to one or more digits of the user. The touch screen 118 may use LCD (liquid crystal display) technology, or LPD (light emitting polymer display) technology, although other display technologies may be used in other embodiments. The touch screen 118 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 118.

The key module 120 also provides an audio interface between a user and the mobile electronic device 100. The user may press different keys to activate corresponding function of the mobile electronic device 100.

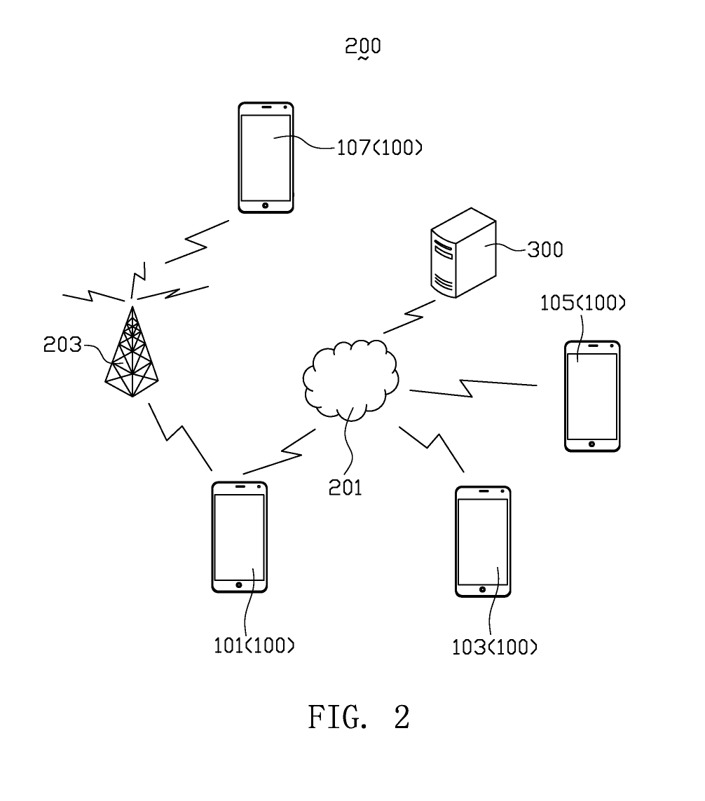

FIG. 2 is a schematic view of an emergency calling system. As shown in FIG. 2, the system includes a server 300 and at least one mobile electronic device 100. In the shown embodiment, the at least one mobile electronic device 100 includes a first mobile electronic device 101, a second mobile electronic device 103, a third mobile electronic device 105 and a fourth mobile electronic device 107. The first mobile electronic device 101, the second mobile electronic device 103, and the third mobile electronic device 105 communicate with the server 300, or communicate with each other via a first network 201. The first mobile electronic device 101 and the fourth mobile electronic device 107 communicate with each other via a second network 203. Examples of the first network includes, but not limited to, wireless area network or a mobile communication network. The second network 203, for example, is a mobile communicate network. The first network 201 and the second network 203 may be different networks, or a same network such as mobile communication network. It is to be understood that there may be more mobile electronic device 100 in the system.

During operation of the emergency calling system, one of the mobile electronic devices 100 acts as the caller, while the other mobile electronic devices 100 act as the callee. For example, in the present embodiment, the first mobile electronic device 101 is the caller, and the other mobile electronic devices 100 are the callees.

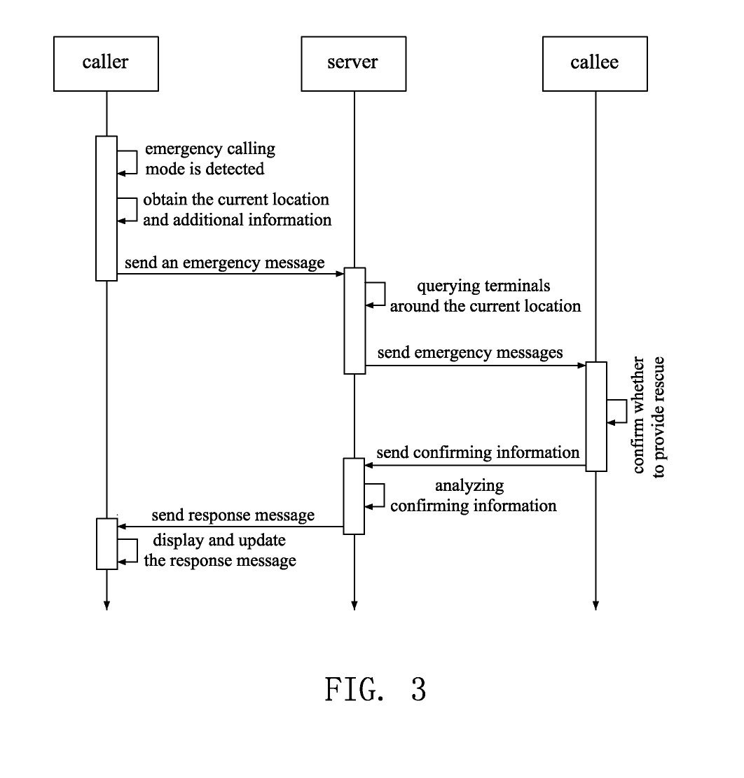

FIG. 3 is a sequence diagram of the emergency calling system. First, an emergency calling mode is triggered in the first mobile electronic device 101 (caller). After the emergency calling mode is triggered, the first mobile electronic device 101 positions its current location using the positioning module 112 and other message content. The message content includes, but not limited to, texts, photos, audios, videos and any combination thereof. Then, the first mobile electronic device 101 sends an emergency message (including the current location and the message content) the server 300 via the first network.

After receiving the emergency message, the server 300 parses the emergency message to extract the current location, and queries other available terminals within a predetermined range around the current location. For example, a database can be used to store locations of all the terminals (e.g., the mobile electronic device 100). By querying the database, the available terminals can be obtained. The predetermined range, for example, is a circular area having a radius of 500 meters around the current location. After obtaining the available terminals, the server 300 sends the emergency message to these terminals via the first network 201.

The available terminals receive the emergency message from the server 300, output the emergency message, and wait for the users' confirmation. If a user confirms to provide rescue, a corresponding terminal sends a confirmation message to the serve 300.

Accordingly, the server 300 analyzes the confirmation messages from all the available terminals. Then, the server 300 returns a response message to the caller (the first mobile electronic device 101). The first mobile electronic device 101 receives the response message and outputs the response message such that the caller could know the calling result. The response message, for example, may include identifiers of users who confirm to provide help, locations of the users, and specialty of the users. The specialty, for example, means what kind of help the users could provide. Examples of the specialty include, but not limited to, first aid, emergency surgery, emergency drugs, cars, and etc.

It is to be noted that the above flow is only an illustrative example. The operation procedure of the emergency system is not limited to the example, and the information transmitted in the emergency system is also not limited to the above examples.

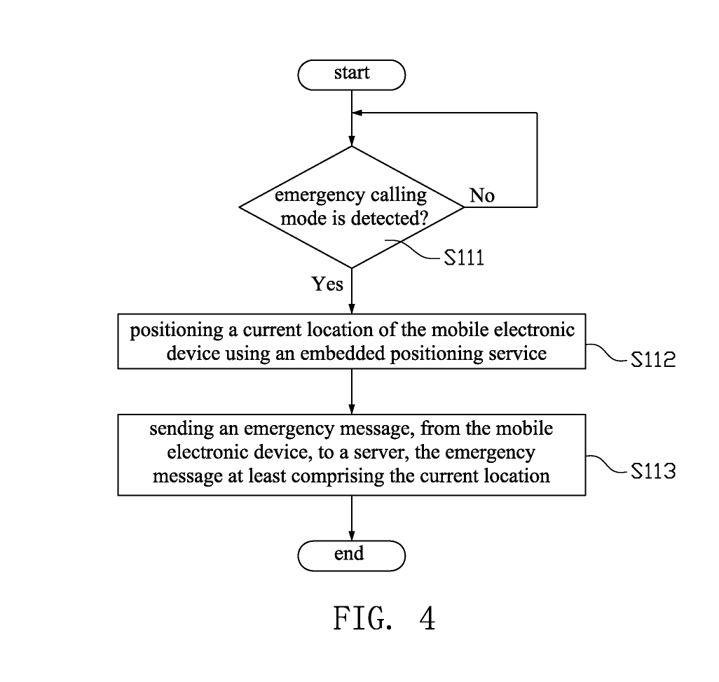

FIG. 4 is a flow chart of a method of making an emergency call in a mobile electronic device. Referring to FIG. 4, the method includes the following steps.

Step S111, detecting whether a user interaction with the first mobile electronic device 101 triggers an emergency calling mode; if yes, a step S113 is executed; otherwise the step S111 can be repeated.

Step S113, positioning a current location of the first mobile electronic device 101 using an embedded positioning service. The positioning service, for example, is a system service based on the positioning module 112.

Step S115, sending an emergency message, from the first mobile electronic device 101, to the server 300. The emergency message at least includes the current location of the first mobile electronic device 101.

According to above method, the emergency calling mode is triggered by user interaction. Then, the current location of the mobile electronic device is obtained automatically. The emergency message sent to the serve 300 includes the current location. Therefore, the server 300 is capable of finding out terminals around the current location, and the efficiency of providing emergency aid is improved.

User interactions with the mobile electronic device 101 includes, but not limited to, key operations, touch screen operations, voice instructions, and gesture based on spatial sensing. All of these user interactions are capable of triggering the emergency calling mode. Specifically, the emergency calling mode is detected if the user interaction meets certain conditions. The certain conditions, for example, mean a predetermined pattern. However, the certain conditions are not limited to the predetermined pattern, and any user operation that can trigger the emergency calling mode can be regarded as the certain conditions.

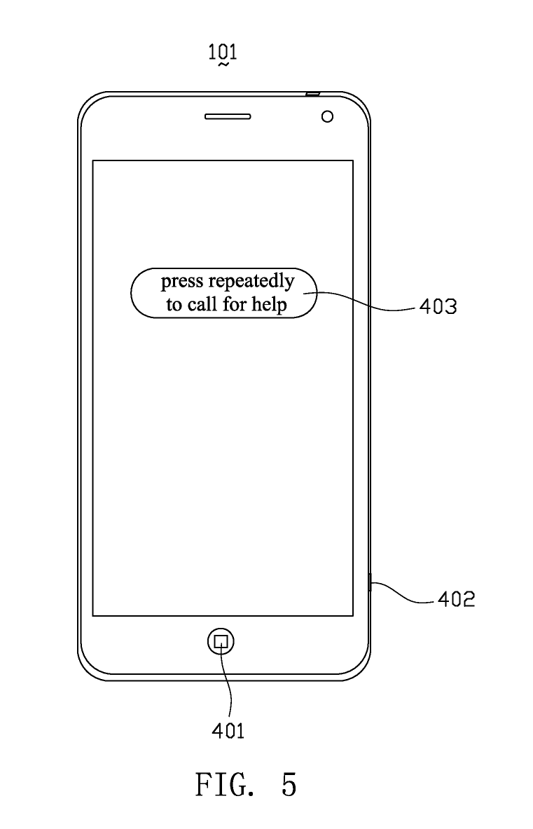

In one embodiment, the emergency calling mode is triggered by one or more keys or buttons. For example, referring to FIG. 5, the first mobile electronic device 101 includes one or more keys, such as a “home” key 401 at a front surface of the first mobile electronic device, and a “shoot” key 402 at a side surface of the first mobile electronic device. In step S111, if the key 401 and/or key 402 are operated by the user in a manner satisfying a predefined pattern, the emergency calling mode is detected. The predefined pattern, for example, means the key is pressed repeatedly for predefined times (e.g., four, five or more times) during a predetermined time period (e.g., 2 s).

In one embodiment, the emergency calling mode is triggered by a touch screen. For example, referring to FIG. 5, a user interface object (e.g., a button) 403 is displayed on the touch screen 118. In step S111, if the user interface object is pressed repeatedly for predefined times (e.g., four, five or more times) during a predetermined time period (e.g., 2 s), the emergency calling mode is detected. In this embodiment, the predefined times is set to four, five or more for avoiding the emergency message is sent when the user presses the under interface object by mistake. In an alternative manner, the emergency calling mode is detected when the user interface object 403 is pressed for a long time period (e.g., over 2 s).

In one embodiment, the emergency calling mode is triggered by a voice instruction. The voice instruction is implemented in a voice recognition method. For example, by recognizing what the user said, the emergency calling mode is detected if the meaning of the voice is calling for help. Voice recognition can be performed in the first mobile electronic device 101, or in an alternative manner, a recorded voice is sent to a remote server and then the remote server performs the voice recognition and returns the recognition result. In addition, the voice recognition process is not necessary under some conditions. For example, the first mobile electronic device 101 or a cloud server could stores a preset emergency voice. In this way, the recorded voice can be compared with the preset emergency voice directly. If the recorded voice is same as the preset one, the emergency calling mode is detected.

In one embodiment, the emergency calling mode is triggered by a gesture based on spatial sensing. The first mobile electronic device 101 may include one or more sensors such as accelerometers or gyroscopes. Based on these sensors, the first mobile electronic device 101 could sense its movements. In step S111, if a spatial trajectory of the first mobile electronic device 101 satisfies a certain pattern, for example, the trajectory forms a “SOS” pattern; the emergency calling mode is detected. It is to be noted that the “SOS” pattern can be replaced with any other suitable pattern. In addition, the spatial trajectory is not limited as the trajectory of the first mobile electronic device 101. For example, by detecting the motion of other objects, such as human body, the emergency calling mode can also be triggered.

In one embodiment, the emergency calling mode is triggered by vital signs of the user of the first mobile electronic device 101. Examples of the vital signs include, but not limited to, heart rate, blood pressure, at etc. These vital signs can be detected by sensors embedded in the first mobile electronic device 101, or external sensors. Once the vital signs exceed a predetermined range, the emergency calling mode is detected.

In addition, above methods can also be used in combination. For example, if the user presses the user interface object repeatedly for predetermined times (e.g., four to five times or more) and a voice instruction (e.g., a shout) is detected, the emergency calling mode is triggered.

Furthermore, the detecting of the emergency calling mode doesn't affected by the operation state of the first mobile electronic device 101. For example, no matter the first mobile electronic device 101 is locked or not, the emergency calling mode should be detected. In other words, the step S111 can be performed in a locked state of the first mobile electronic device 101. Moreover, a boot loader of the first mobile electronic device 101 can be modified to achieve that the emergency calling mode can be detected at a power off state, and the emergency message can be sent immediately after the first mobile electronic device 101 is powered on. For example, if the power button is pressed for predetermined times in a short time period (e.g., 2 s), an application that performs the aforementioned method can be set as a startup application.

As described above, examples of the message content include, but not limited to, text, photos, audios, videos, and any combination thereof. The message content can be inputted by the user, recorded by the first mobile electronic device 101, or even are pre-stored in the first mobile electronic device 101. To record live message content, corresponding sensors or applications of the first mobile electronic device 101 should be launched. The sensors or applications can be launched manually by the user. For example, the sensors or applications can be started using user interface objects. In addition, the sensors or applications can be launched automatically. That is, once the emergency calling mode is detected, the sensors or applications can be started to record live message content. The recorded message content includes, but not limited to, audios, videos, photos, vital signs and any combination thereof. In one embodiment, if the emergency calling mode is detected in the step S111, the camera module 114 is launched to take photos or videos. In another embodiment, if the emergency calling mode is detected in the step S111, the microphone is started to record audios.

As shown in FIG. 3, after receiving the emergency message, the server 300 queries other available terminals within a predetermined range around the current location. Thus, the server 300 needs to know location of all the other terminals.

In one embodiment, the mobile electronic devices 100 get the current location thereof using the positioning module 112 for predetermined time interval, such as 5 minutes. Then, the mobile electronic devices 100 upload the location thereof to the server 300.

In one embodiment, the mobile electronic devices 100 get the current location thereof using the positioning module 112 for a short time interval, such as 1 minute. Then, the current location is compared with previous location, and a distance between is calculated. If the distance exceeds a predetermined value, such as, 500 meters, the current location of the mobile electronic devices 100 are uploaded to the server 300. According to this manner, network flux consumed by the mobile electronic devices 100 to update the current location can be saved.

In one embodiment, the mobile electronic devices 100 get the current location thereof using the positioning module 112 if detecting that active base station is changed. Then, the mobile electronic devices 100 upload the current location to the server 300. Generally, the signal of a base station can only cover a certain range, in other words, the signal of the base station can be used to roughly position the mobile electronic devices 100. According to this method, the frequency of uploading the current location can be reduced and thus power consumed by the mobile electronic devices 100 can be saved.

The above described method can also be used in combination. For example, if the distance doesn't exceed the predetermined value, but the current location isn't uploaded to the server 300 over 5 minutes, then the current location can be uploaded to the server 300 forcedly.

The location of the mobile electronic devices 100 can be stored in a database. By querying the database, the server 300 could find out all the terminals within a predetermined range around the current location of the first mobile electronic device 101. Accordingly, the server 300 sends emergency messages to these terminals (callees), respectively.

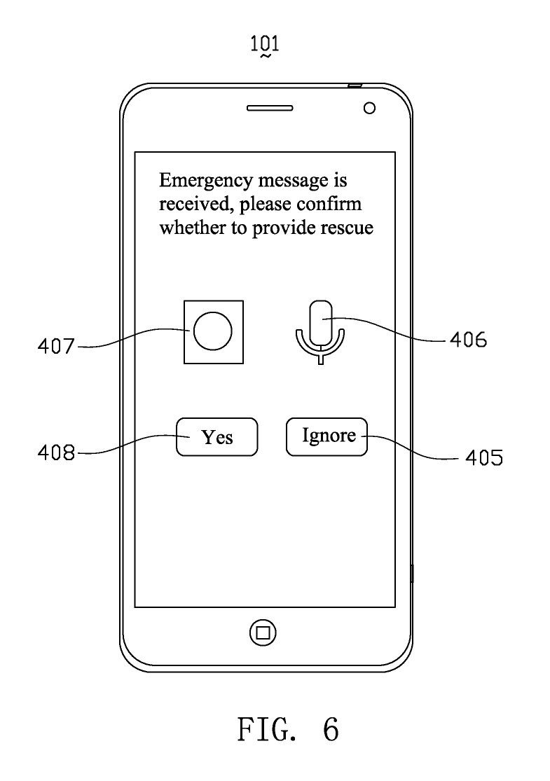

Referring to FIG. 6, after receiving the emergency message from the server 300, the terminals may display the emergency message and wait for the users' confirmation. For example, a user interface object 404 (e.g., a button) is displayed. The user can click the user interface object 404 to confirm provide help. A user interface object 405 (e.g., a button) can also be displayed. The user can click the user interface object 405 to decline or ignore the emergency message. After confirmed by the user, the terminals may send a response message to the server 300.

The response message may include the current location of the terminals, and may further include additional information, which includes, but not limited to, texts, photos, audios, videos, and any combination thereof. For example, the terminals can display a user interface object 406 (e.g., a button). The user can click the user interface object 406 to record audios. The terminals can also display a user interface object 407 (e.g., a button). The user can click the user interface object 407 to take photos or videos.

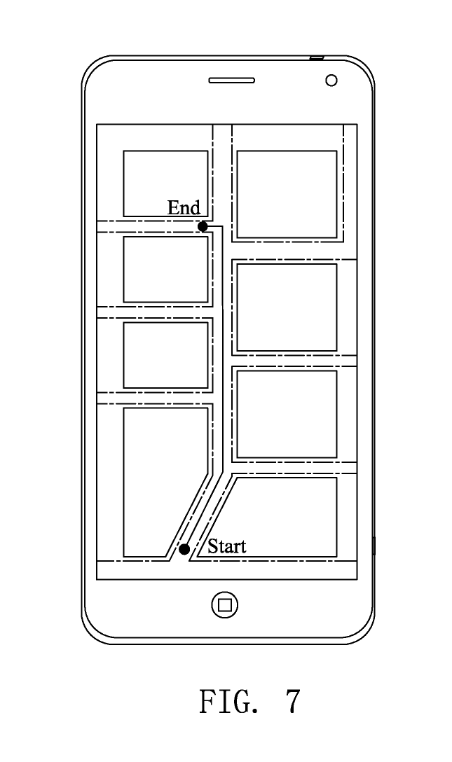

In addition, as shown in FIG. 7, to help the callees going to the current location of the first mobile electronic device 101, a navigation interface can be displayed. Navigation route between the callees and the current location of the first mobile electronic device 101 can be calculated and displayed on the navigation interface.

After confirmed by the user, the terminals may increase the frequency of uploading its current location to the server 300 such that the server 300 is capable of knowing the location of the users that confirm to provide help.

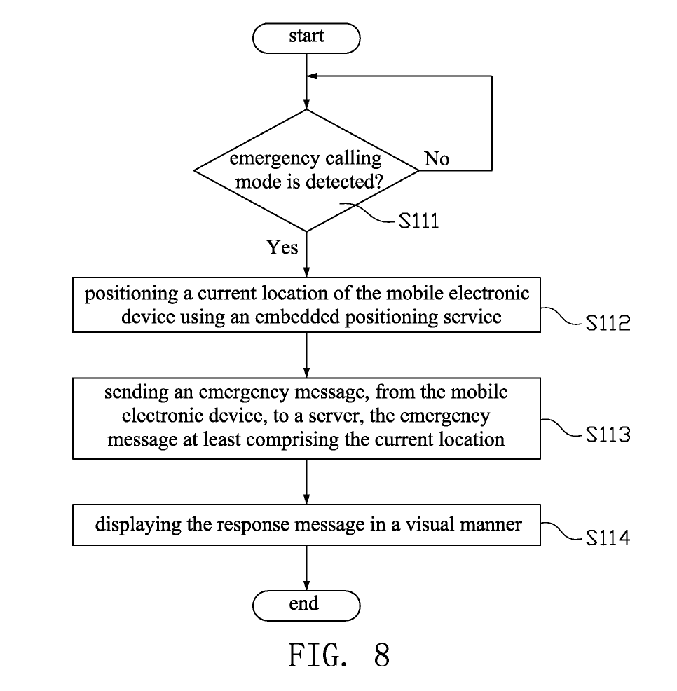

FIG. 8 is a flow chart of a method for making an emergency call in a mobile electronic device according to an embodiment. The method of FIG. 8 is similar to the method shown in FIG. 6, excepting that the present method further includes: a step S114, displaying the response message in a visual manner.

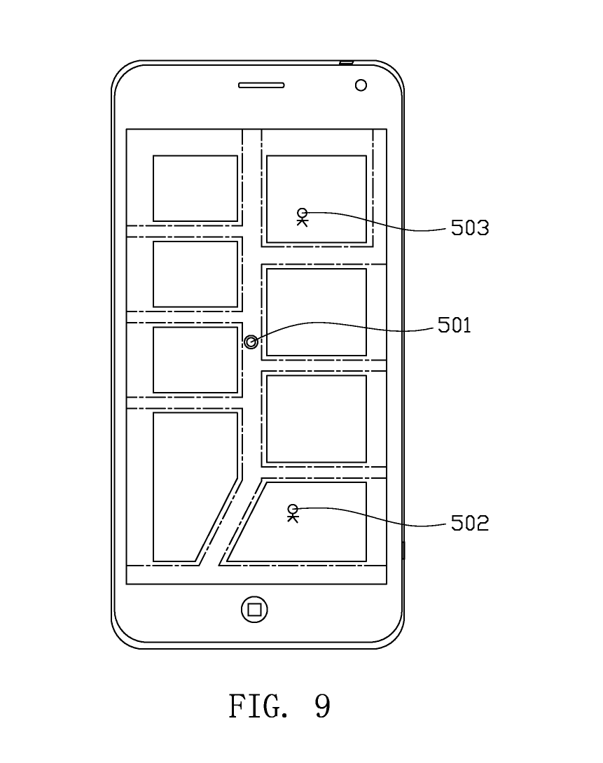

In detail, after receiving the response message from the server 300, the first mobile electronic device 101 parses the identifier of the user that confirms to provide rescue (rescuer), and display the location of the rescuer on an electronic map. Referring to FIG. 9, a user interface object 501 (e.g., an icon) represents the location of the first mobile electronic device 101, a user interface object 502 and a user interface object 503 (e.g., an icon) represents locations of two rescuers, respectively.

After each time interval, such as 30 seconds or a shorter time period, the first mobile electronic device 101 can request the latest location of the users that confirm to provide rescue and then update the locations of these users. The interface shown in FIG. 9 let the caller known the location of the rescuers.

In addition, it is not convenient for the caller to watch the display screen under some situations. Then, the locations of the rescuers can be played with sound.

FIG. 10 is a flow chart of a method for making an emergency call in a mobile electronic device according to an embodiment. The method of FIG. 10 is similar to the method shown in FIG. 8, excepting that the present method further includes: a step S114, establishing an instant messaging session with the rescuers according to an instant messaging protocol.

For example, as shown in FIG. 9, when the user clicks the interface object 502 or the interface object 503, the instant messaging session can be created. Accordingly, an interface (i.e., a window) of the messaging session can be shown. The caller may communicate with the rescuers using texts, audios, or videos in the interface. The instant messaging protocol is not limited, and any suitable protocols can be used.

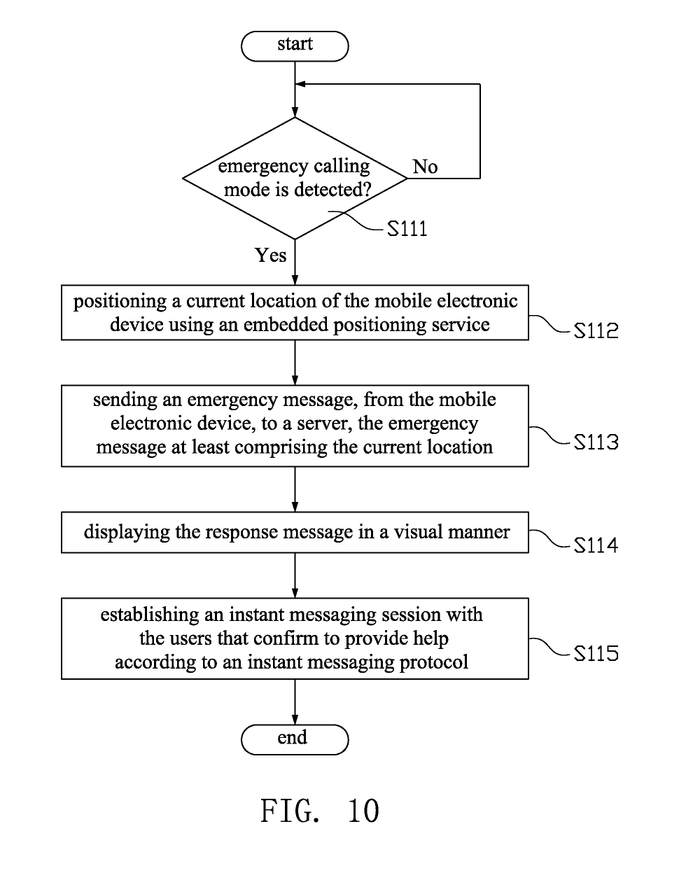

In the above embodiments, the callees are all in a predetermined range around the caller. However, the distance is not limited. For example, referring to FIG. 11, in another embodiment, the method further includes a step S116, sending the emergency message to a preset contact from the mobile electronic device. The preset contact, for example, is a mobile phone number, an email address, an instant messaging account and any combination thereof. The mobile phone number can be the emergency contact of the caller or a phone number of a public assistance agency. It is understood that no matter which type contact is selected, a terminal is required to receive the emergency message. As shown in FIG. 2, the terminal receives the emergency message sent to the preset contact is the fourth mobile electronic device 107.

If the preset contact is a mobile phone number, the emergency message can be sent with a short message, which includes the current location of the caller and additional information.

If the preset contact is an email address, the emergency message can be sent with an email, which includes the current location of the caller and additional information.

If the preset contact is an instant messaging account, the emergency message can be sent with an instant message, which includes the current location of the caller and additional information.

In addition, the emergency message to the preset contact is not limited to be sent by the first mobile electronic device 101. For example, the emergency message to the preset contact can also be sent by the server 300. Under such a situation, the preset contact of all the users could be stored in the server 300 or in a database connected to the server 300.

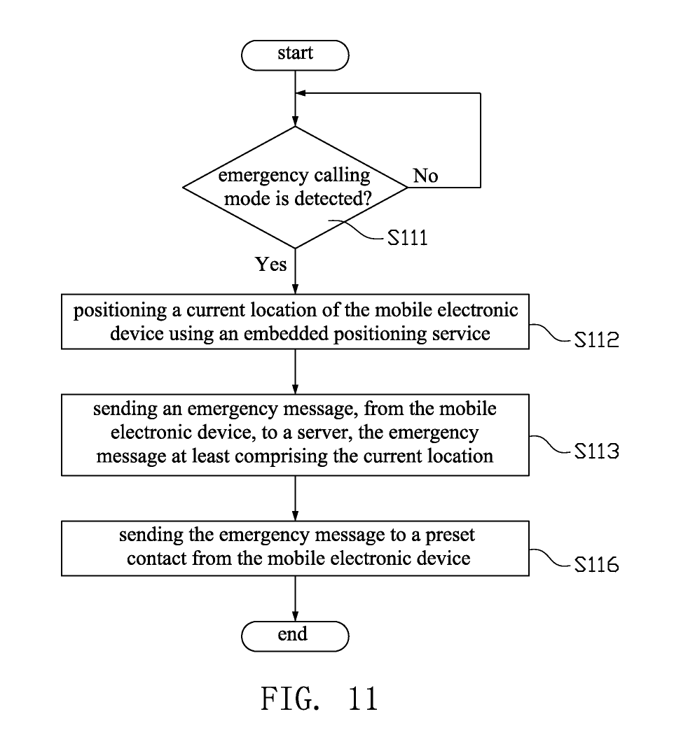

FIG. 12 is a block diagram of a mobile electronic device according to an embodiment. As shown in FIG. 12, the mobile electronic device includes a detecting module 11, a positioning obtaining module 12 and a first calling module 13.

The detecting module 11 is configured for detecting whether a user interaction with the mobile electronic device triggers an emergency calling mode.

The positioning obtaining module 12 is configured for positioning a current location of the mobile electronic device using an embedded positioning service in the first mobile electronic device 101.

The first calling module is configured for sending an emergency message, from the first mobile electronic device 101, to the server 300. The emergency message at least includes the current location of the first mobile electronic device 101.

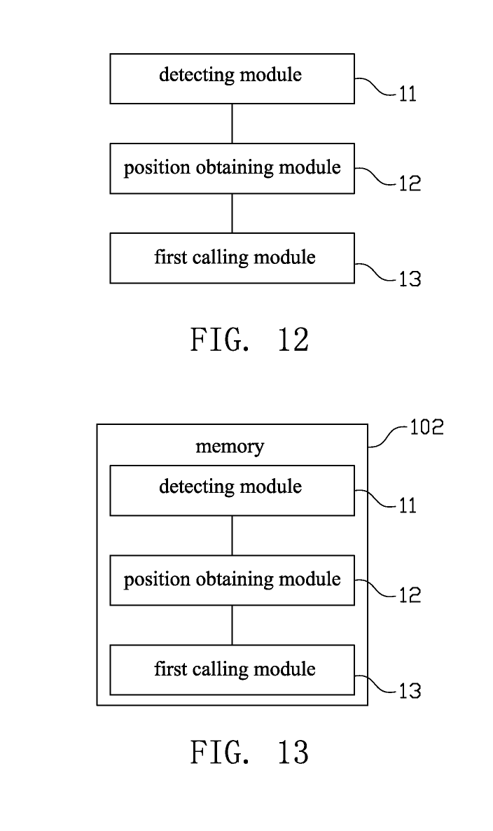

As used herein, the term “module” may refer to software programs or modules that stored in the memory 102 (as shown in FIG. 13). However the modules may also refer to, be part of, or include an Application Specific Integrated Circuit (ASIC); an electronic circuit; a combinational logic circuit; a field programmable gate array (FPGA); a processor (shared, dedicated, or group, e.g., the processor 106) that executes code; other suitable hardware components that provide the described functionality; or a combination of some or all of the above, such as in a system-on-chip. The term module may include memory (shared, dedicated, or group, e.g., the memory 102) that stores code executed by the processor.

In one embodiment, the emergency calling mode is triggered by one or more keys. For example, referring to FIG. 5, the first mobile electronic device 101 includes one or more keys, such as a “home” key 401 at a front surface of the first mobile electronic device, and a “shoot” key 402 at a side surface of the first mobile electronic device. If the detecting module 11 detects that the key 401 and/or key 402 are operated by the user in a manner satisfying a predefined pattern, the emergency calling mode is detected. The predefined pattern, for example, means the key is pressed repeatedly for predefined times (e.g., four, five or more times) during a predetermined time period (e.g., 2 s).

In one embodiment, the emergency calling mode is triggered by a touch screen. For example, referring to FIG. 5, a user interface object (e.g., a button) 403 is displayed on the touch screen 118. If the detecting module 11 detects that the user interface object is pressed repeatedly for predefined times (e.g., four, five or more times) during a predetermined time period (e.g., 2 s), the emergency calling mode is detected. In this embodiment, the predefined times is set to four, five or more for avoiding the emergency message is sent when the user presses the under interface object by mistake. In an alternative manner, the emergency calling mode is detected when the user interface object 403 is pressed for a long time period (e.g., over 2 s).

In one embodiment, the emergency calling mode is triggered by a voice instruction. The voice instruction is implemented in a voice recognition method. For example, by recognizing what the user said, the emergency calling mode is detected if the meaning of the voice is calling for help. Voice recognition can be performed in the first mobile electronic device 101, or in an alternative manner, a recorded voice is sent to a remote server and then the remote server performs the voice recognition and returns the recognition result. In addition, the voice recognition process is not necessary under some conditions. For example, the first mobile electronic device 101 or a cloud server could stores a preset emergency voice. In this way, the recorded voice can be compared with the preset emergency voice directly. If the detecting module 11 detects that the recorded voice is same as the preset one, the emergency calling mode is detected.

In one embodiment, the emergency calling mode is triggered by a gesture based on spatial sensing. The first mobile electronic device 101 may include one or more sensors such as accelerometers or gyroscopes. Based on these sensors, the first mobile electronic device 101 could sense its movements. If the detecting module 11 detects that a spatial trajectory of the first mobile electronic device 101 satisfies a certain pattern, for example, the trajectory forms a “SOS” pattern; the emergency calling mode is detected. It is to be noted that the “SOS” pattern can be replaced with any other suitable pattern. In addition, the spatial trajectory is not limited as the trajectory of the first mobile electronic device 101. For example, by detecting the motion of other objects, such as human body, the emergency calling mode can also be triggered.

In one embodiment, the emergency calling mode is triggered by vital signs of the user of the first mobile electronic device 101. Examples of the vital signs include, but not limited to, heart rate, blood pressure, at etc. These vital signs can be detected by sensors embedded in the first mobile electronic device 101, or external sensors. Once the detecting module 11 detects that the vital signs exceed a predetermined range, the emergency calling mode is detected.

In addition, above methods can also be used in combination. For example, if the user presses the user interface object repeatedly for predetermined times (e.g., four to five times or more) and a voice instruction (e.g., a shout) is detected, the emergency calling mode is detected by the detecting module 11.

Furthermore, the detecting of the emergency calling mode doesn't affected by the operation state of the first mobile electronic device 101. For example, no matter the first mobile electronic device 101 is locked or not, the emergency calling mode should be detected by the detecting module 11. In other words, the detecting module 11 can work in a locked state of the first mobile electronic device 101. Moreover, a boot loader of the first mobile electronic device 101 can be modified to achieve that the emergency calling mode can be detected at a power off state, and the emergency message can be sent immediately after the first mobile electronic device 101 is powered on. For example, if the power button is pressed for predetermined times in a short time period (e.g., 2s), an application that performs the aforementioned method can be set as a startup application.

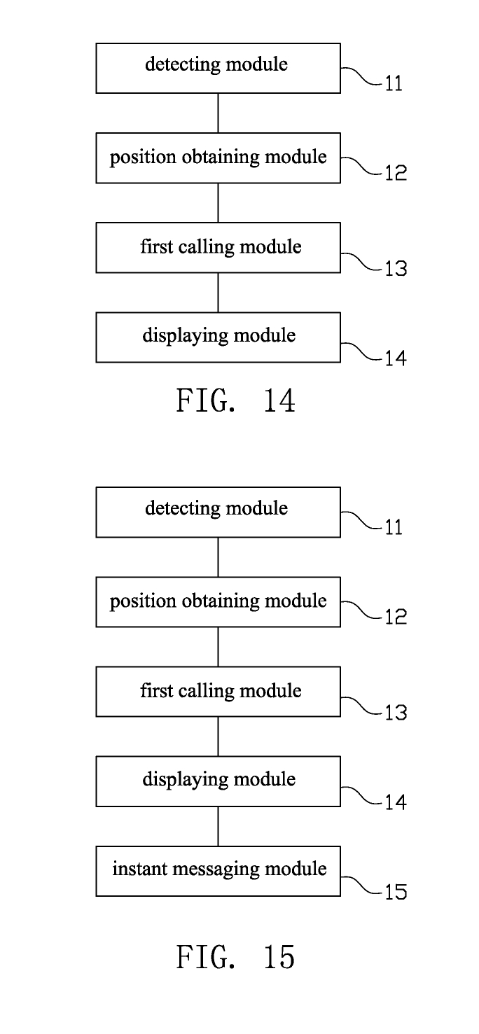

FIG. 14 is a block diagram of a mobile electronic device according to an embodiment. The mobile electronic device is similar to that shown in FIG. 12, excepting that the present device further includes a displaying module 14.

The displaying module 14 is configured for displaying the response message from the server 300 in a visual manner. For example, the displaying module 14 is configured for: parsing identifiers of rescuers from the response message; and displaying the current location of the mobile electronic device and the locations of the rescuers, as shown in FIG. 9. The displaying module 14 is further configured for updating the location of the rescuers periodically such that the caller is capable of knowing the rescuing progress.

FIG. 15 is a block diagram of a mobile electronic device according to an embodiment. The mobile electronic device is similar to that shown in FIG. 12, excepting that the present device further includes an instant messaging module 15.

The instant messaging module 15 is configured for establishing an instant messaging session with the rescuers according to an instant messaging protocol. For example, as shown in FIG. 9, when the user clicks the interface object 502 or the interface object 503, the instant messaging session can be created. Accordingly, an interface (i.e., a window) of the messaging session can be shown. The caller may communicate with the rescuers using texts, audios, or videos in the interface. The instant messaging protocol is not limited, and any suitable protocols can be used.

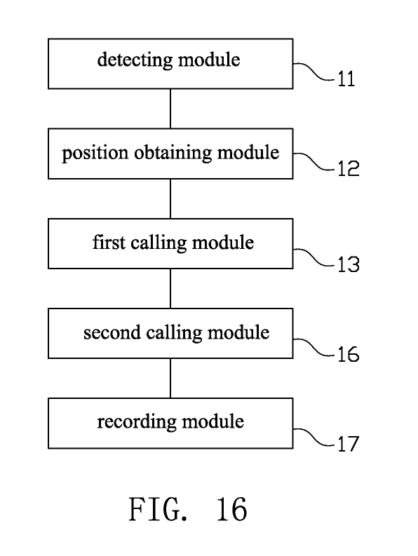

FIG. 16 is a block diagram of a mobile electronic device according to an embodiment. The mobile electronic device is similar to that shown in FIG. 12, excepting that the present device further includes a second calling module 16.

The second calling module 16 is configured for sending the emergency message to a preset contact from the first mobile electronic device 101. The preset contact, for example, is a mobile phone number, an email address, an instant messaging account and any combination thereof. The mobile phone number can be the emergency contact of the caller or a phone number of a public assistance agency.

If the preset contact is a mobile phone number, the emergency message can be sent with a short message, which includes the current location of the caller and additional information.

If the preset contact is an email address, the emergency message can be sent with an email, which includes the current location of the caller and additional information.

If the preset contact is an instant messaging account, the emergency message can be sent with an instant message, which includes the current location of the caller and additional information.

In addition, the mobile electronic device may further include a recording module 17, configured for recording message content automatically after the emergency calling mode is detected. The message content may include, but not limited to, audios, videos, photos, and any combination thereof. In one embodiment, the recording module 17 is configured for launching the camera 114 to take photos or vides. In another embodiment, the recording module 17 is configured for recording audios using a microphone.

The above descriptions are only preferred embodiments, and are not intended to limit the present invention. Any one of ordinarily skilled in the art would make replacements or modifications to the above technical solutions within the spirit and the scope of the present invention to obtain equivalent embodiments, and these equivalent embodiments should also be included in the scope of the present invention.

### INDUSTRIAL PRACTICITY

The present invention provides a method of making an emergency call in a mobile electronic device. The current location of the mobile electronic device is obtained automatically, and the emergency message sent to the serve includes the current location. Therefore, the server is capable of finding out terminals around the current location, and the efficiency of providing emergency aid is improved.

What is claimed is:

1. A method of making an emergency call in a mobile electronic device, comprising:
detecting whether a user interaction with the mobile electronic device triggers an emergency calling mode;
positioning a current location of the mobile electronic device using an embedded positioning service;
sending an emergency message, from the mobile electronic device, to a server, the emergency message at least comprising the current location.

2. The method of claim 1, wherein the electronic device comprises a key;
and the emergency calling mode is detected if the key is pressed predetermined times in a predetermined time period.

3. The method of claim 1, wherein the electronic device comprises a key and a microphone; and the emergency calling mode is detected if the key is pressed predetermined times in a predetermined time period and a voice input is detected from the microphone.

4. The method of claim 1, wherein the emergency calling mode is detected if a preset voice instruction is detected.

5. The method of claim 1, wherein the emergency calling mode is detected if a preset swinging pattern of the mobile electronic device is detected.

6. The method of claim 1, wherein the emergency calling mode is detected if vital signs of a user exceed a preset range.

7. The method of claim 1, wherein the step of detecting the emergency calling mode is performed when the mobile electronic device is in a locked state.

8. The method of claim 1, further comprising performing following steps at a server:
querying other available terminals within a predetermined range around the current location;
sending SOS messages to the available terminals and receiving confirming information from users; and
sending a response message to the mobile electronic device according to the confirming information.

9. The method of claim 1, further comprising displaying the response message in a visual manner in the mobile electronic device.

10. The method of claim 9, wherein the step of displaying the response message comprises:
parsing users that confirm to provide help from the response message; and
displaying the current location of the mobile electronic device and the locations of the users that confirm to provide help.

11. The method of claim 10, further comprising: establishing an instant messaging session with the users that confirm to provide help according to an instant messaging protocol.

12. The method of claim 1, further comprising: sending the emergency message to a preset contact from the mobile electronic device.

13. The method of claim 12, wherein the preset contact is a contact of a public assistance agency.

14. The method of claim 1, further comprising: recording message content automatically when the emergency calling mode is detected.

15. The method of claim 14, wherein the step of recording message content comprises: taking a photo or a video with a camera automatically.

16. The method of claim 14, wherein the step of recording message content comprises: recording a voice message with a microphone.

17. A mobile electronic device, comprising:
memory;
one or more processors; and
one or more modules stored in the memory and configured for execution by the one or more processors, the one or more modules comprising instructions:
to detect whether a user interaction with the mobile electronic device triggers an emergency calling mode;
to position a current location of the mobile electronic device using an embedded positioning service; and
to send an emergency message, from the mobile electronic device, to a server, the emergency message at least comprising the current location.

18. The mobile electronic device of claim 17, further comprising performing following steps at a server:
querying other available terminals within an area of a predetermined size around the current location;
sending SOS messages to the available terminals and receiving confirming information from users; and
sending a response message to the mobile electronic device according to the confirming information.

19. The mobile electronic device of claim 17, further comprising displaying the response message in a visual manner in the mobile electronic device.

20. A computer readable storage medium, storing one or more modules, which when executed by a mobile electronic device, causes the mobile electronic device to perform a method comprising:
detecting whether a user interaction with the mobile electronic device triggers an emergency calling mode;
positioning a current location of the mobile electronic device using an embedded positioning service; and
sending an emergency message, from the mobile electronic device, to a server, the emergency message at least comprising the current location.
